(19) United States
(12) Patent Application Publication
(10) Pub. No.: US 2023/0289565 A1
(43) Pub. Date: Sep. 14, 2023

(54) METHOD FOR THE SECURE USE OF A FIRST NEURAL NETWORK ON AN INPUT DATUM

(71) Applicant: IDEMIA IDENTITY & SECURITY FRANCE, Courbevoie (FR)

(72) Inventors: Hervé CHABANNE, Courbevoie (FR); Linda GUIGA, Courbevoie (FR); Vincent DESPIEGEL, Courbevoie (FR); Stephane GENTRIC, Courbevoie (FR)

(73) Assignee: IDEMIA IDENTITY & SECURITY FRANCE, Courbevoie (FR)

(21) Appl. No.: 18/178,576

(22) Filed: Mar. 6, 2023

(30) Foreign Application Priority Data
Mar. 9, 2022 (FR) 22 02041

(51) Int. Cl. G06N 3/0455; H04L 9/32

(52) U.S. Cl. CPC G06N 3/0455; H04L 9/3239

(57) ABSTRACT

A method for the secure use of a first neural network on an input datum, the method including the implementation, by data processing device of a terminal, of the following steps: (a) constructing a second neural network corresponding to the first neural network, into which is inserted, at the input of a target layer of the first neural network, at least one auto-encoder neural network trained to add a parasitic noise to its input; (b) using the second neural network on the input datum.

### GENERAL TECHNICAL FIELD

The present invention relates to the field of artificial intelligence, and in particular to a method for the secure use of a first neural network on an input datum.

### PRIOR ART

Neural networks (or NN) are widely used for data classification.

After a phase of machine learning (which is generally supervised, that is to say on a reference database of already classified data), a neural network “learns” and becomes capable of applying the same classification to unknown data on its own. More precisely, the value of weights and parameters of the NN is progressively modified until it is capable of implementing the targeted task.

Significant progress has been made in recent years, both on the architectures of neural networks and on learning techniques (in particular in deep learning) or even on the learning bases (size and quality thereof), and tasks previously considered impossible are nowadays performed by neural networks with excellent reliability.

One challenge encountered by neural networks is the existence of “adversarial attacks”, that is to say imperceptible changes that, when applied to an input of the neural network, change the output significantly. The document A Simple Explanation for the Existence of Adversarial Examples with Small Hamming Distance by Adi Shamir, Itay Safran, Eyal Ronen, and Orr Dunkelman, https://arxiv.org/pdf/1901.10861v1.pdf discloses for example how an adversarial attack applied to an image of a cat may lead to it being misclassified as an image of guacamole.

The idea is that of observing that a neural network contains an alternation of linear layers and non-linear layers implementing an activation function, such as ReLU. This non-linearity leads to “critical points” with a jump in the gradient, and it is thus possible to geometrically define, for each neuron, a hyperplane of the input space of the network, such that the output is at a critical point. The hyperplanes of the second layer are “folded” by the hyperplanes of the first layer, and so on.

Once an attacker has succeeded in identifying the division into hyperplanes explained above, he is able to determine a vector that makes it possible, from a point in the input space, to cross a hyperplane and therefore to modify the output.

It is therefore understood that it is essential to succeed in securing neural networks.

A first approach is that of increasing the size, the number of layers and the number of parameters of the network so as to complicate the task for the attacker. If this works, all this does is slow down the attacker, on the one hand, and above all this worsens performance as the neural network is then unnecessarily cumbersome and difficult to train.

A second approach is that of limiting the number of inputs able to be submitted to the neural network, or at least of detecting suspicious sequences of inputs. However, this is not always applicable, since the attacker may legally have access to the neural network, for example having paid for unrestricted access.

The Applicant has also proposed, in application FR3110268, a technique consisting in inserting, into the network to be secured, at least one convolutional neural network approximating the identity function, called Identity CNN.

This technique proves to be effective against adversarial attacks but was developed mainly to combat “reverse engineering” techniques allowing an attacker to extract the parameters and the model of any neural network as long as it is possible to submit a sufficient number of well-chosen requests thereto, or to use a side channel (electromagnetism type) to observe additional information, meaning that it is possible to further improve the situation with regard specifically to the problem of adversarial attacks.

### PRESENTATION OF THE INVENTION

According to a first aspect, the present invention relates to a method for the secure use of a first neural network on an input datum, the method being characterized in that it comprises the implementation, by data processing means of a terminal, of the following steps:
(a) constructing a second neural network corresponding to the first neural network, into which is inserted, at the input of a target layer of the first neural network, at least one auto-encoder neural network trained to add a parasitic noise to its input;
(b) using the second neural network on said input datum.

According to some advantageous and non-limiting features

Said parasitic noise added to its input by the auto-encoder is based on said input.

Said target layer is within the first neural network.

Step (a) comprises selecting said target layer of the first neural network from among the layers of said first neural network.

The method comprises a preliminary step (a0) of obtaining the parameters of said auto-encoder and of the first neural network.

For a learning base of pairs of a reference datum and a noisy version of the reference datum equal to the sum of the reference datum and a possible parasitic noise, the auto-encoder is trained to predict said noisy version of a reference datum from the corresponding reference datum.

Step (a0) comprises, for each of a plurality of reference data, computing the possible parasitic noise for said reference datum on the basis of the reference datum, so as to form said learning base.

Said possible parasitic noise for the reference datum is determined entirely by a cryptographic hash of said reference datum for a given hash function.

Step (a0) comprises obtaining the parameters of a set of auto-encoder neural networks trained to add a parasitic noise to their input, step (a) comprising selecting, from said set, at least one auto-encoder to be inserted.

Step (a) furthermore comprises selecting, beforehand, a number of auto-encoders of said set to be selected.

Step (a0) is a step implemented by data processing means of a learning server.

According to a second and a third aspect, the invention relates to a computer program product comprising code instructions for executing a method according to the first aspect for the secure use of a first neural network on an input datum; and a storage means able to be read by a computer equipment on which a computer program product comprises code instructions for executing a method according to the first aspect for the secure use of a first neural network on an input datum.

### PRESENTATION OF THE FIGURES

Other features and advantages of the present invention will become apparent on reading the following description of one preferred embodiment. This description will be given with reference to the appended drawings, in which:

FIG. 1 is a diagram of an architecture for implementing the method for the secure use of a first neural network on an input datum according to the invention;

FIG. 2 schematically shows the steps of one embodiment of the method for the secure use of a first neural network on an input datum according to the invention.

### DETAILED DESCRIPTION

### Architecture

The present invention proposes a method for the secure use of a first neural network (1^{st} NN) involving the generation of a second neural network (2^{nd} NN).

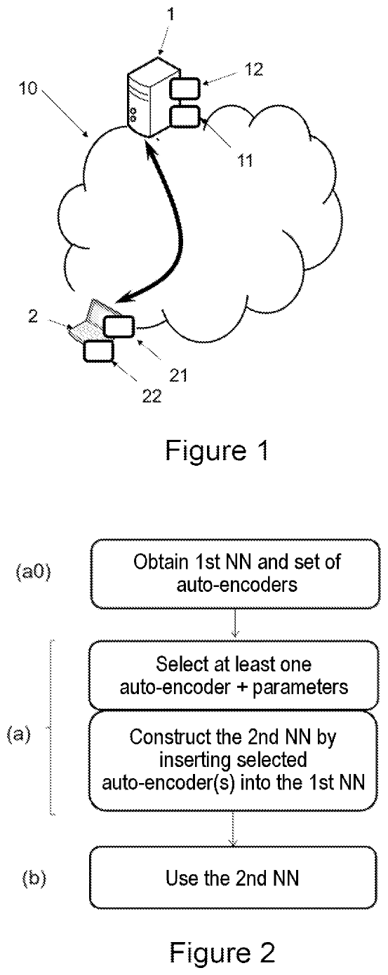

This method is implemented within an architecture as shown by FIG. 1, by virtue of at least one server 1 and one terminal 2. The server 1 is the learning equipment (training the 1^{st} NN and/or an auto-encoder) and the terminal 2 is a use equipment (implementing said secure use method). Said use method is implemented on an input datum, and is for example a classification of the input datum from among multiple classes if it is a classification NN (but this task is not necessarily a classification, even though this is the most conventional).

A limit will not be drawn to any type of NN in particular, even though this typically involves an alternation of linear layers and non-linear layers with an activation function, in particular ReLU (Rectified Linear Unit), which is equal to σ(x)=max(0, x). It will therefore be understood that each hyperplane corresponds to the set of points of the input space such that an output of a linear layer is equal to zero.

In any case, each equipment 1, 2 is typically a remote computer equipment connected to a wide area network 10 such as the Internet in order to exchange data. Each one comprises data processing means 11, 21 of processor type, and data storage means 12, 22 such as a computer memory, for example a hard drive.

The server 1 stores a learning database, that is to say a set of data for which the associated output is already known, of data that are for example already classified (as opposed to what are known as the input data that it is precisely desired to process). This may be a learning base with high commercial value that it is sought to keep secret.

It will be understood that it is still possible for the equipments 1 and 2 to be the same equipment, or the learning base may even be a public base.

It should be noted that the present method is not limited to one type of NN, and therefore not to one particular nature of data, and the input data or learning data may be representative of images, sounds, etc.

In one preferred embodiment, personal data, and even more preferably biometric data, are involved, the input data or learning data typically being representative of images or even directly images of biometric features (faces, fingerprints, irises, etc.), or directly pre-processed data resulting from the biometric features (for example the position of minutiae in the case of fingerprints).

The 1^{st} NN may for example be a CNN designed particularly to process images of biometric features.

### Principle

The present invention proposes again to complicate the task of attackers without complicating the NN by inserting networks, but this time by seeking to intentionally add a noise. In other words, a slight performance degradation is accepted, which secures the NN by making it far more robust than everything that has been proposed up to now.

For convenience, the original NN to be protected will be called “first neural network”, and the modified and thus secured NN will be called “second neural network”.

In more detail, securing the first network with a second network consists in integrating, into its architecture, at least one auto-encoder neural network trained to add a parasitic noise to its input.

This “noise-adding” auto-encoder does not substantially modify the operation of the NN, since its outputs are close to its inputs, in particular with regard to low-frequency components, see below. On the other hand, it renders adversarial attacks ineffective.

It will be noted that the encoder does not make do with approximating its input, but expressly adds a noise thereto, advantageously based on the input (that is to say the auto-encoder is trained to add, to its input, a parasitic noise based on said input).

Mathematically, for an input x, the output of the auto-encoder is thus A(x)≈x+n(x), where n is the parasitic noise (and x+n(x) is used as ground truth for learning, as will be seen), while the output of the known Identity CNN is I(x)≈x (x is used as ground truth for learning).

Preferably, the parasitic noise added by the auto-encoder has a norm of at least 0.1% of the norm of the input, that is to say ∥n(x)∥≥0.0001*∥x∥.

The idea of using an auto-encoder to add noise is original and counterintuitive, since auto-encoders are generally used conversely to denoise their input, and reference is made to a “denoising” auto-encoder.

An auto-encoder, or “encoder/decoder”, is a neural network comprising two successive blocks: an encoder block producing a high-level feature map representative of its input, called “code” of the input (the encoding may be seen as compression of the input), and a decoder block (usually) regenerating the input from the code (that is to say training is performed through unsupervised learning in which the input is taken as ground truth). The space of the code generally has a dimension smaller than that of the input space, and the encoder may thus be seen as a low-pass filter (that retains the low-frequency components of the input), hence its ability to denoise the input.

According to one possible embodiment:
the encoder consists of a sequence of convolution layers CONV and of activation layers that alternate (for example ReLU), possibly with interposed batch normalization layers BN, in particular 4 CONV+BN+ReLU blocks raising the number of channels from 3 at input (RGB image) to 16, then 32, then 32 again and finally 64 (the “code”);
the decoder consists of a sequence of transposed convolution layers TCONV and of activation layers that alternate (for example ReLU), possibly with interposed batch normalization layers BN, in particular 4 TCONV+BN+ReLU blocks lowering the number of channels from 64 at input (the “code”) to 64 again, then 32, then 16 and finally 3 (input+parasitic noise) The convolutions may have filters of size 3×3.

It will be noted that auto-encoders have already been proposed for removing adversarial attacks, since they act essentially on high-frequency components.

Documents (1) DDSA: a Defense against Adversarial Attacks using Deep Denoising Sparse Autoencoder, Yassine Bakhti, Sid Ahmed Fezza, Wassim Hamidouche, Olivier Déforges, (2) PuVAE: A Variational Autoencoder to Purify Adversarial Examples, Uiwon Hwang1, Jaewoo Park1, Hyemi Jang1, Sungroh Yoon1, Nam Ik Cho, and (3) DSCAE: a denoising sparse convolutional autoencoder defense against adversarial examples Hongwei Ye, Xiaozhang Liu, Chun-Liang Li, each propose for example using a denoising auto-encoder to filter adversarial attacks so as to “purify” the data upstream of the NN.

The auto-encoder is thus trained specifically to suppress the adversarial attack on input data (in learning, the input datum is taken as ground truth), which is complex (it is necessary to have examples of adversarial attacks to form the learning base) and which will actually work only in known situations (attacks similar to those used for learning).

The present invention goes against this: as explained, the auto-encoder is trained to add noise rather than to denoise. Specifically, this will be tantamount to the auto-encoder adding a high-frequency component during decoding (while retaining the low-frequency component), which will flood a potential adversarial attack and render it ineffective. In other words, the auto-encoder proves to be effective in adding a noise that is effective against an adversarial attack, while at the same time having only a limited impact on the output of the NN since the low-frequency components of the input are retained.

There are many advantages to this solution:
the auto-encoder is able to be trained independently, and without having to have examples of adversarial attacks, thereby making it effective for any NN against a wide range of attacks while at the same time being easy to train.
as will be seen further below, the auto-encoder may be placed anywhere in the NN and it is even possible to insert several thereof so as to create parasitic “diversity”, all chosen dynamically and randomly where applicable, thereby leaving an attacker no chance of managing to generate an adversarial attack that might work.

### Method

According to a first aspect, what is proposed, with reference to FIG. 2, is a method for the secure use of the 2^{nd} NN on an input datum, implemented by the data processing means 21 of the terminal 2.

The method advantageously begins with a “preparatory” step (a0) of obtaining the parameters of the 1^{st} NN and of said auto-encoder, preferably a plurality of auto-encoders, in particular of various architectures, trained on different bases, etc., so as to define a set that is varied if possible; this will be seen in more detail later. It should be noted that it is possible for said set to contain, besides the one or more auto-encoders, other neural networks trained to add a parasitic noise to their input.

This step (a0) may be a step of training each of the networks on a dedicated learning base, in particular the 1^{st} NN, preferably implemented by the data processing means 11 of the server 1 for this purpose, but it will be understood that the networks (in particular the auto-encoders) could be pre-existing and taken as they are. In any case, the one or more auto-encoders may be trained in particular on any public database, or even on random data (no need for them to be annotated as it is possible to reconstruct a noise from these data, see below).

A main step (a) comprises constructing said 2nd NN corresponding to the 1^{st} NN, into which is inserted at least one auto-encoder neural network trained to add a parasitic noise to its input, in particular one or more selected auto-encoders. In other words, step (a) is a step of inserting the one or more auto-encoders into the 1^{st} NN. If there are multiple selected auto-encoders, they may be inserted one after the other, at various locations.

To this end, step (a) advantageously comprises selecting one or more auto-encoders from among said set of auto-encoders, for example randomly. Other “insertion parameters” may be selected, in particular a position in the 1^{st} NN (target layer), see below. In any case, it is still possible for the set of auto-encoders to contain just one auto-encoder, such that there is no need for selection, or even for the auto-encoder to be trained on the fly.

Insertion is understood to mean the addition of the layers of the auto-encoder upstream of the “target” layer of the 1^{st} NN, such that the input of this layer is immediately at the output of the auto-encoder. In other words, the auto-encoder interferes with the input of the target layer in order to replace it with its output.

The target layer is preferably a linear layer (and not a non-linear layer with an activation function for example), such that the auto-encoder is inserted at the input of a linear layer of the 1^{st} NN.

The target layer is preferably a layer within the 1^{st} NN, that is to say a layer other than the first (between the second layer and the last). Particularly preferably, the target layer is thus a linear layer within the 1^{st} NN.

Step (a) may also comprise, as explained, the selection of the target layer.

This selection may again be made randomly and dynamically, that is to say new target lagers are drawn for each new request to use the 1^{st} NN, but also in a sequence, or else based on contextual data, and in particular the input datum. The present invention will not be limited to any way of selecting in particular the target layer/the one or more auto-encoders, as long as there is an active choice from among multiple possibilities so as to add entropy in order to complicate the task even further for a possible attacker.

In practice, the selection may be made according to the following protocol (each step being optional—each choice may be random or predetermined):
1. a number of auto-encoders to be inserted is chosen;
2. as many auto-encoders as this number are drawn from the set of auto-encoders (with or without being put back);
3. for each auto-encoder that is drawn, a target layer to be acted upon (that is to say at the input of which the auto-encoder will be inserted) is chosen from among the layers (in particular linear and/or internal layers) of the 1^{st} NN.

With regard to point 3., it should be noted that two auto-encoders may be chosen to act on the same target layer: they are arranged in sequence.

Lastly, it should be noted that the selection and construction actions may be partially nested (and therefore implemented at the same time): if there are multiple auto-encoders to be inserted, it is possible to determine the insertion parameters for the first one, insert it, determine the insertion parameters for the second one, insert it, etc. Additionally, as explained, the target layer may be selected on the fly in step (a).

At the end of step (a), it is assumed that the 2^{nd} NN is constructed. Then, in a step (b), this 2^{nd} NN may be used on said input datum, that is to say the 2^{nd} NN is applied to the input datum and this gives an output datum that may be provided to the user of the terminal 2 without any risk of being able to lead back to the 1^{st} NN.

The idea of having dynamic selections is that the attacker is not able to adapt. It should be noted that, as an alternative or in addition, it is also possible to construct multiple 2^{nd} NNs (with different selections) and consolidate their responses (output data) so as to have an even more robust “meta network”.

### Training of the Auto-Encoder

As explained, the method advantageously begins with a step (a0) of obtaining the parameters of the 1^{st} NN and of at least one auto-encoder. In other words, during step (a0), the auto-encoder is trained to add a parasitic noise to its input, that is to say to generate, as output A(x), the sum of its input x and the parasitic noise n(x).

It is possible to proceed in many ways.

According to a first mode, it is possible to proceed quite simply directly from an existing learning database in its current state containing learning data, which are pairs of a “reference” input datum and its noisy version equal to the sum of the reference datum and a parasitic noise (that is to say {x, x′}, where x′ may be decomposed as x+n).

According to a preferred second mode, pairs are generated by computing, for a reference datum x, a possible parasitic noise n(x) for this datum using an algorithm. For example, n(x) may be a centred Gaussian noise for example with a standard deviation of 0.01 or 0.05 minimum for CIFAR10 (in particular if the adversarial attacks are computed on the L² norm). Another possibility, within the context of the L^{∞} norm, is to consider “salt and pepper” noise (and therefore to add black and white points if the input datum is an image).

To this end, use is made of a pseudorandom number generator (in particular with a uniform probability density), based on which pseudorandom numbers it is possible to compute a noise that satisfies the desired distribution, in particular a Gaussian one, using an appropriate sampling method (for example the inverse transform method or the Ziggurat algorithm). The pseudorandom number based on which the noise is generated is called a seed.

Particularly advantageously, so that the noise depends on the input, use is made of a cryptographic hash of x with a given hash function as seed to generate noise, that is to say n(x)=f(hash(x)), where f is an appropriate transformation for changing from a uniform distribution to a target distribution. Indeed, by defining a hash function, its output may be seen as a random variable with a uniform distribution.

Said possible parasitic noise for a reference datum is then determined entirely by a cryptographic hash of said reference datum for a given hash function.

It is therefore thus possible, starting from a plurality of reference data {xᵢ} (which may even be taken randomly), to compute for each A(xᵢ)=xᵢ+n(xᵢ), so as to obtain the learning base {xᵢ, A(xᵢ)}, and train the auto-encoder to predict A(xᵢ) from xᵢ.

### Computer Program Product

According to a second and a third aspect, the invention relates to a computer program product comprising code instructions for executing (in particular on the data processing means 11, 21 of the server 1 or of the terminal 2) a method according to the first aspect of the invention for the secure use of a first neural network on an input datum, and also storage means able to be read by a computer equipment (a memory 12, 22 of the server 1 or of the terminal 2) on which this computer program product is contained.

1. A method for the secure use of a first neural network on an input datum, wherein the method comprises implementing with a data processor of a terminal, the following steps:
(a) constructing a second neural network corresponding to the first neural network, into which is inserted, at the input of a target layer of the first neural network, at least one auto-encoder neural network trained to add a parasitic noise to its input;
(b) using the second neural network on said input datum.

2. The method according to claim 1, wherein said parasitic noise added to its input by the auto-encoder is based on said input.

3. The method according to claim 1, wherein said target layer is within the first neural network.

4. The method according to claim 1, wherein step (a) comprises selecting said target layer of the first neural network from among the layers of said first neural network.

5. The method according to claim 1, comprising a preliminary step (a0) of obtaining the parameters of said auto-encoder and of the first neural network.

6. The method according to claim 5, wherein, for a learning base of pairs of a reference datum and a noisy version of the reference datum equal to the sum of the reference datum and a possible parasitic noise, the auto-encoder is trained to predict said noisy version of a reference datum from the corresponding reference datum.

7. The method according to claim 2, wherein step (a0) comprises, for each of a plurality of reference data, computing the possible parasitic noise for said reference datum on the basis of the reference datum, so as to form said learning base.

8. The method according to claim 7, wherein said possible parasitic noise for the reference datum is determined entirely by a cryptographic hash of said reference datum for a given hash function.

9. The method according to claim 5, wherein step (a0) comprises obtaining the parameters of a set of auto-encoder neural networks trained to add a parasitic noise to their input, step (a) comprising selecting, from said set, at least one auto-encoder to be inserted.

10. The method according to claim 9, wherein step (a) furthermore comprises selecting, beforehand, a number of auto-encoders of said set to be selected.

11. The method according to claim 5, wherein step (a0) is a step implemented by a data processing device of a learning server.

12. A computer program product comprising code instructions for executing a method according to claim 1, for the secure use of a first neural network on an input datum, when said program is executed by a computer.

13. A storage device able to be read by a computer equipment on which a computer program product comprises code instructions for executing a method according to claim 1, for the secure use of a first neural network on an input datum.
